(19) United States
(12) Patent Application Publication
(10) Pub. No.: US 2010/0114945 A1
(43) Pub. Date: May 6, 2010

(54) Methods, Systems, and Computer Readable Media for Associating a Network User with a Commercial Entity Associated with a Predetermined Profile and for Associating a Network User with a Commercial Entity Based on a Search Query

(76) Inventor: Bentley Jason Olive, Apex, NC (US)

Correspondence Address: OLIVE LAW GROUP, PLLC, 130 EDINBURGH SOUTH DRIVE, SUITE 107, CARY, NC, 27511, US

(21) Appl. No.: 12/264,930

(22) Filed: Nov. 5, 2008

(51) Int. Cl. G06F 7/10; G06F 17/30

(52) U.S. Cl. 707/770; 707/E17.014

(57) ABSTRACT

Methods, systems, and computer readable media for associating a network user with a commercial entity associated with a predetermined profile and for associating a network user with a commercial entity based on a search Query are disclosed. According to one aspect, a method includes receiving a user query directed to one or more commercial entities associated with a predetermined profile. The method also includes sending the user query to a commercial entity associated with the predetermined profile and having a commercial account. Further, the method includes receiving a response to the user query from the commercial entity for presentation of the response to a network user associated with the user query.

### TECHNICAL FIELD

The subject matter disclosed herein relates generally to associating consumers with commercial entities. More particularly, the subject matter disclosed herein relates to methods and systems for associating network users with commercial entities having a predetermined profile.

### BACKGROUND ART

Commercial entities, such as corporations and entrepreneurs, generally use media such as television, radio, newspapers, magazines, and the Internet to advertise to prospective consumers or customers. To reach a more responsive set of prospective customers, advertisers have used demographic studies. For example, advertisers may use broadcast events such as baseball games to advertise action movies to a younger male audience. However, even with demographic studies and entirely reasonable assumptions about the typical audience of various media outlets, advertisers recognize that much of their advertisement budget is simply wasted because the target audience is not interested in the advertisement they are receiving.

Interactive media, such as the Internet, has the potential for better targeting of advertisements. For example, some websites provide an information search functionality that is based on query keywords entered by the user seeking information. This query can be used as an indicator of the type of information of interest to the user. By comparing the user query to a list of keywords specified by an advertiser, it is possible to provide some form of targeted advertisements to these search service users. An example of such a system is the ADWORDS® system offered by Google Inc.

Although targeted advertisements have provided businesses with the ability to more efficiently advertise to prospective customers, this form of advertising does not realize the Internet's full potential for allowing interactivity between commercial entities and prospective customers. Particularly, targeted advertisements do not facilitate a dialogue between the two. Rather, these advertisements simply provide a link for directing prospective customers to static websites where the customers are presented information about the commercial entities.

For these reasons, it is desirable to provide enhanced interactivity between commercial entities and their prospective customers. By enhancing interactivity among commercial entities and prospective customers, customer confidence with commercial entities can be increased, thereby increasing the likelihood that a customer will seek the services or products provided by a commercial entity. This may be particularly important for startup commercial entities that have not yet gained a wide reputation.

### SUMMARY

In accordance with this disclosure, novel methods, systems, and computer readable media for associating a network user with a commercial entity associated with a predetermined profile and for associating a network user with a commercial entity based on a search query are provided.

It is an object of the present disclosure therefore to provide novel methods, systems, and computer readable media for associating a network user with a commercial entity associated with a predetermined profile and for associating a network user with a commercial entity based on a search query. This and other objects as may become apparent from the present disclosure are achieved, at least in whole or in part, by the subject matter described herein.

### BRIEF DESCRIPTION OF THE DRAWINGS

Exemplary embodiments of the subject matter will now be explained with reference to the accompanying drawings, of which:

FIG. 1 is a block diagram of an environment within which the subject matter disclosed herein may be implemented;

FIG. 2 is a block diagram of a system for associating a network user with a commercial entity in accordance with an embodiment of the subject matter disclosed herein; and

FIG. 3 is a flow diagram of an exemplary process of associating a network user with a commercial entity according to an embodiment of the subject matter disclosed herein.

### DETAILED DESCRIPTION

Methods, systems, and computer readable media for associating a network user with a commercial entity associated with a predetermined profile and based on a search query are disclosed. According to one embodiment, a method for associating a network user with commercial entities associated with a predetermined profile can include receiving a user query directed to a commercial entity associated with a predetermined profile. The method can also include sending a portion or the entire user query to one or more commercial entities associated with the predetermined profile and having a commercial account. Further, the method can include receiving a response to the user query from the one or more commercial entities having the commercial account for presentation of the response to a network user associated with the user query. An exemplary advantage of this method and other methods and systems described herein is that improved interactivity between commercial entities having a particular profile and prospective customers is provided.

In one embodiment, user queries and corresponding responses can be communicated over any suitable communications network. For example, the user queries and responses can be communicated over the Internet, a wide area network, a local area network, a wireless network, and the like. In addition, management of commercial entity and network user accounts can be managed over a suitable communications network.

As used herein, the term “predetermined profile” refers to a profile associated with a commercial entity. The predetermined profile of a commercial entity can include information regarding the commercial entity's business-type category and geographic location. For example, the business-type category of a commercial entity can be lawn care service. In addition, for example, the geographic location of the commercial entity can be a particular state or metropolitan area where the entity provides the lawn care service. The predetermined profile can also include a commercial entity's name, employee's names, address, product names, service names, and the like.

As used herein, the term “profile identifier” refers to an identifier for a profile associated with a commercial entity. In one example, one or more profile identifiers of a commercial entity can be stored in a database table and can be used for comparison to data contained in a user query or a search query. The comparison can be used to determine a match between data in the query to the profile identifier. If a match is found, the query can be associated with the commercial entity, and a portion or the entirety of the query sent to the commercial entity. A match can be an exact match or a match to closely related data and identifiers. For example, “lawn care” can be a match with “lawn service”.

As used herein, the term “client device” refers to any suitable electronic device for communicating with a server or system via a communications network. Exemplary client devices include a mobile phone, a PDA, a network component, a television, a computer, and a device configured to implement a web portal.

As used herein, the term “network database” refers to any suitable collection of content (also referred to as “data”) associated with a database. The database may be stored in a single memory component or distributed among a plurality of components in a network. Exemplary data in the network database includes image content, video content, audio content, text content, links, metadata, and/or any other content suitable for storage on a memory component. In one example, the data may include all or a portion of the content accessible via the Internet.

As used herein, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

In one embodiment, the method can include determining a profile identifier based on the user query, and sending the user query to one or more commercial entities having a matching profile identifier. For example, the user query may contain one or more terms or identifiers. A database table may include a list of commercial entities, contact information for each commercial entity, and one or more profile identifiers for each commercial entity. Terms contained in the user query or associated with the user query can be compared to profile identifiers in the database table. If a term in the user query matches a profile identifier of a commercial entity, a portion or the entirety of the user query can be presented to the matching commercial entity by use of the contact information.

In another example, one or more identifiers associated with the user query can be compared to identifiers in the database table containing commercial entity profile information. In one example, an identifier can be a geographic location of where the user query originated. For example, the user query can be contained in a message, and the source of the message determined by its data. The geographic location can be compared to geographic location information in the database table. If the geographic location matches a geographic location listed for a commercial entity, the user query can be presented to the matching commercial entity. A representative of the commercial entity can access the user query, and generate a response to the query.

In another embodiment, a commercial entity and a service provider can agree or contract to a service for implementing the methods and systems disclosed herein. For example, the commercial entity and service provider can contract that the service provider will receive user queries directed to commercial entities associated with a predetermined profile. User queries can be sent to commercial entities associated with the predetermined profile and having a commercial account with the service provider. The commercial entity can send a response to the user query to the service provider for presentation to the network user that sent the user query. The commercial entity can compensate the service provider in any suitable manner, such as by paying monthly or per presentation of a response to the network user. The compensation can be in the form of electronic compensation from the commercial entity in return for sending the response to the network user.

In another embodiment, statistics can be generated based on the queries and the query responses. For example, numbers of queries and query responses from network users and commercial entities can be generated and stored in a database. The statistics can be provided to network users and commercial entities.

In yet another embodiment, network users can generate and send scores for query responses. A score can reflect a perceived quality of a query response provided by a commercial entity. In one example, the scores of a commercial entity can be collected and presented to network users for reflecting a perceived quality of responses provided by the commercial entity. The scores from a plurality of network users for a particular commercial entity can be analyzed and statistics generated. The statistics can be sent to one or more network users.

According to another embodiment of the subject matter disclosed herein, a method for associating a network user with a commercial entity based on a search query can include analyzing a search query based on a profile identifier associated with a commercial entity having a commercial account. The method can also include sending notification of the search query to the commercial entity based on the analysis. Further, the method can include receiving a response to the search query from the commercial entity for presentation of the response to a network user associated with the search query.

In one embodiment, a search query can include data such as one or more search terms or phrases. The search terms and phrases can be compared with profile identifiers associated with commercial entities. Notification of the search query can be sent to commercial entities having a profile identifier that matches one of the search terms or phrases. The commercial entities receiving the notification of the search query can view the query and respond with a search query response. The response can be sent to the network user originating the search query. The notification, search query, and response can be communicated via the Internet.

In one embodiment, the search query can be received as result of a search performed by a network user using an Internet search engine. For example, a network user may be using a search engine, such as the GOOGLE™ or YAHOO!® search engines (available from Google, Inc., of Mountain View, Calif., and Yahoo! Inc., of Sunnyvale, Calif., respectively). The user may enter a search query including one or more words, terms or phrases into a text box of a search engine webpage. The search query may be sent to the search engine for search of a plurality of cached webpages. The data of the search query may also be analyzed. For example, one or more search terms may be analyzed by comparing the terms, words, or phrase to profile identifiers of commercial entities. Next, notification of the search query may be sent to commercial entities having a profile identifier matching a search term, word or phrase. The notification can be communication of the search query and/or related information to the commercial entity. In one example, the search engine can be an Internet search engine, but may alternatively be any other search engine capable of searching electronically stored data.

A search engine may communicate search engine results to a network user in response to a search query. The search engine results may be delivered to the network user in a webpage containing a list of the results. In addition, in accordance with the subject matter disclosed herein, a response from a commercial entity may be sent to the network user. The response may be sent to the network user in a webpage containing text, images, video, a website link, and/or other media provided by the commercial entity. For example, the response can be an advertisement for the commercial entity or information specific to the search query, such as a response where an employee of the commercial entity reads the response and generates a tailored response to the query. A webpage containing the search engine results can be sent prior to the webpage containing the commercial entity's response.

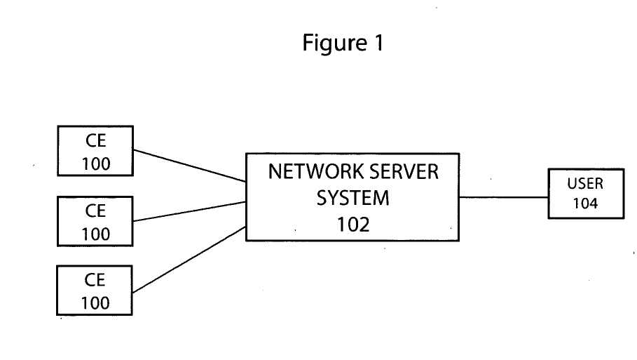

FIG. 1 is a block diagram illustrating an environment within which the subject matter disclosed herein may be implemented. Referring to FIG. 1, the environment includes a plurality of commercial entities 100, a network server system 102, and a network user 104. A commercial entity can be a representative of a corporation or an entrepreneur. The representative can operate or otherwise utilize one or more client devices for communication with system 102. The network user can be a prospective customer of the commercial entities, and can operate or otherwise utilize a client device capable of communicating with system 102. Although one network user is shown in FIG. 1, multiple network users may access and utilize advertising system 102 as disclosed herein.

System 102 may be connected to the Internet and may include servers capable of operating a website accessible by customer entities 100 and network user 104. System 102 may utilize the Internet for communicating messages to customer entities 100 and network user 104. Alternative to the Internet, any other suitable network may be utilized for delivering communications between system 102, customer entities 100, and network user 104.

System 102 may receive from network user 104 a user query directed to commercial entities 100 associated with a profile. The user query may be include text, voice data, or the like by which the user desires to search for data, ask a question, provide commentary, or the like. The user query may be included in a message sent to system 102 by a client device operated by network user 104. In one example, system 102 or another client device may communicate a webpage for display to network user 104, and the webpage includes a component through which the user can enter a user query. The user query can then be sent to system 102.

Each commercial entity 100 may register with system 102 by an online registration process or by another suitable process. A commercial entity may be associated with a profile identifier, such as a business-type category or a geographic location of the commercial entity. A geographic location may be a region where the commercial entity currently conducts or will conduct business. A business-type category refers to a category of business type that the commercial entity conducts or will conduct. For example, the commercial entity may provide computer services or accounting services. The profile identifier can be a term or phrase, and can be provided by a commercial entity during the online registration process or later. A commercial entity may also provide to system 102 other profile identifiers, such as business name, address information, contact names, and the like.

The user query may be generated by network user 104 using a network device and may be communicated to system 102. The user query may be directed to one or more commercial entities based on its content. In particular, the user query may be directed to a commercial entity having a predetermined profile if its data matches a profile identifier of the commercial entity. For example, a commercial entity may be a lawn care service or an electronic device producer, and the commercial entity would identify a profile indicating its appropriate business type. The user query can include identification of a profile relevant to the user query. Continuing this example, a user query regarding eradicating weeds from a lawn can identify a lawn care service profile identifier. Further, for example, a user query regarding an electronic consumer device can identify an electronic device producer profile identifier. The profile identifier may also identify a geographic location, such that user queries are only directed to commercial entities associated with a particular geographic location.

System 102 may identify registered commercial entities having a profile identifier relevant to data contained in the user query. The user query may be sent by the system to commercial entities identified as having a profile identifier matching the predetermined profile of the user query. A representative of a commercial entity may utilize a computer connected to the Internet to interface with advertising system 102 for selecting the query for presentation to the representative.

Representatives of the commercial entities may utilize client devices to generate responses to the presented user query. For example, a response may include a text or voice response to the user query. The response may be an answer to a question about a service, a question about a product, or a question associated with the profile. A commercial entity representative can generate the response and send the response via a suitable message to system 102. A response may be received from one or more commercial entities associated with the profile identifier. The commercial entity may be communicated to system 102 via an Internet connection. For example, the commercial entity representative may utilize a computer or other suitable client device for entering a response to the query and for communicating the response to system 102.

As part of a commercial entity registering an account, a commercial entity and the owner of the advertising system can agree to terms by which the commercial entity compensates the advertising system owner for use of the advertising system. Compensation can be made on receipt of a response to a query and communication and/or presentation of the response to a user. For example, the commercial entity can compensate an operator of system 102 for sending its response to a user associated with the user query. The compensation can be in the form of electronic transmittal of funds from an account of the commercial entity to an account of an advertising service operating the advertising system.

The advertising service can verify that sufficient funds are available for use of its services. For example, a commercial entity can prepay for services. In another example, the commercial entity can provide billing information to the advertising system, such as credit card information or banking information. Compensation verification can also be made by a contract between the commercial entity and the advertising system owner.

In response to receiving the user query response and compensation verification, the user query response can be communicated to and presented to network user 104. The commercial entity can benefit from providing the response and the compensation to the operator of system 102 because, due to the contact, a business relationship can thereby be developed between the commercial entity and the user. Further, the query, response, and commercial entity information can be made publicly available for providing public relations exposure for the commercial entity and for providing information to the public.

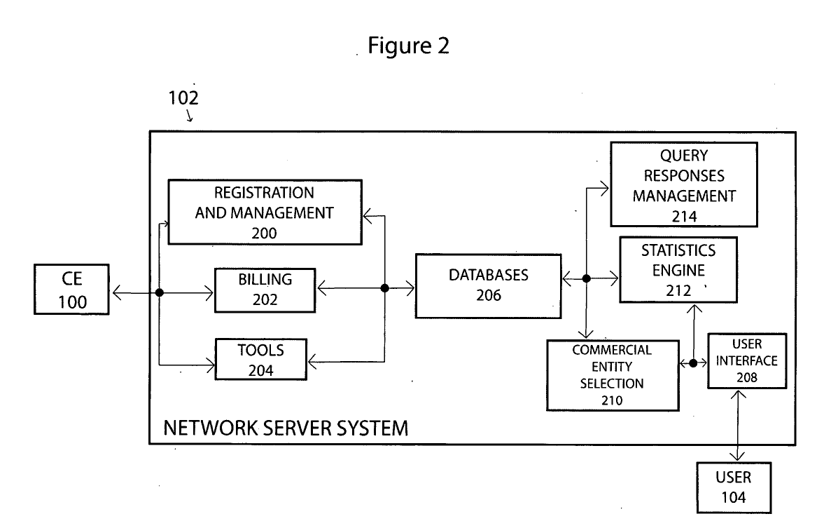

FIG. 2 is a block diagram illustrating a system for associating a network user with a commercial entity in accordance with an embodiment of the subject matter disclosed herein. Referring to FIG. 2, network server system, generally designated 102, can include a registration and management module 200, a billing module 202, a tools module 204, one or more databases 206, a user interface module 208, a commercial entity selection module 210, a statistics engine 212, and a query response management module 214. Although FIG. 2 shows a particular arrangement of modules constituting system 102, those skilled in the art will recognize that not all modules need be arranged as shown, not all modules are required, and that other modules or components may be added to, or replace, those shown.

Registration and management module 200 is the module by which a commercial entity can enter information to register a commercial account and manage the account. The commercial account can include information about the commercial entity, such as its name, contact information, and billing information.

Further, a commercial entity can utilize registration and management module 200 for entering profile identifiers. The profile identifiers can be used to associate a user query or search query with the commercial entity. In one example, a representative of a commercial entity can access a webpage provided by system 102 for entering profile identifiers and other registration information in the form of text. The entered text can be stored in a database table and thereby associated with the commercial entity for comparison to text or other data contained in or associated with a user query or a search query.

Tools module 204 can contain a variety of tools designed to help commercial entity 100 create, monitor, and manage its user queries and query responses, profile identifiers, public relations campaign, information entered during registration, and other information. For example, tools module 204 may contain a tool for helping commercial entity 100 estimate the number of queries the commercial entity will receive for its business type, geographic location, and/or other profile identifier information.

In addition, tools module 204 may be used to help commercial entity 100 to distribute queries directed to the commercial entity among its personnel or representatives. For example, certain queries may contain predetermined keywords, and queries containing these keywords may be routed (e.g., via email) to specialized personnel. In another example, commercial entity 100 may monitor query responses in accordance with the responses' viewing rate by Internet users. Further, for example, commercial entity 100 may monitor query response viewing rate in accordance with keywords contained in the query and/or the query response. Other possible tools may be provided as well. Depending on the nature of the tool, one or more databases 206 may be used to gather or store information.

Tools module 204 may contain a tool for helping commercial entity 100 respond to queries. For example, personnel of commercial entity 100 may communicate query responses via the Internet for responding to queries. The tool may forward the query response to database 206 for storage until accessed as described herein. In one example, a representative of a commercial entity can access a website provided by system 102 for viewing user queries and search queries directed to the commercial entity. In this example, the representative can enter a response to the query and send the query to system 102 via the website. System 102 may manage sending the response to the user originating the user query and may manage statistics related to the response.

Billing module 202 can perform billing-related functions. For example, billing module 202 can generate invoices for a particular commercial entity 100. In addition, billing module 202 may be used by commercial entity 100 to monitor the amount being expended for its query responses. The data required for, or obtained by (such as queries from users, statistical information, and profile information), user interface module 208 can reside in one or more databases 206. A commercial entity can be in a variety of ways, including, but not limited to, payment per query response provided by the commercial entity, and payment at regular intervals (e.g., weekly, monthly, annually, etc.) regardless of the number of query responses posted by the commercial entity.

Databases 206 contain a variety of data used by system 102. In addition to the information mentioned above in reference to registration and management module 200, databases 206 may contain statistical information about queries received from users, queries sent to commercial entities, query responses presented to users, and query responses received from commercial entities, and the like. Although databases 206 are shown in FIG. 2 as one unit, one of ordinary skill in the art will recognize that multiple databases may be employed for gathering and storing information used in advertising system 102.

User interface module 208 can interface with a client device operated by network user 104 to obtain or send information. For example, the client device may send a user query via a network as described herein to user interface module 208. The user query may include a request for information from commercial entities matching a profile identifier, such as a business-type category and/or a geographic location of the commercial entity. In response, user interface module 208 may acknowledge receipt of the user query, and forward the user query to commercial entity selection module 210.

Commercial entity selection module 210 can determine a profile identifier based on the user query or search query. For example, module 210 can analyze the query based on a profile identifier associated with a commercial entity having a commercial account. A term, multiple terms in a particular sequence or any sequence, or other data contained in a query can be a profile identifier. For example, the term “lawn” can be considered a profile identifier for use in performing a lookup in a database table, and matched against commercial entities having the same or a related profile identifier. Further, module 210 may process the user query and may send a portion or the entirety of the user query to one or more matching commercial entities having the matching profile identifier. For example, a portion of the entirety of the user query may be sent to commercial entity 100 shown in FIG. 2.

Information about the query and/or information and about the network user may be received by statistics engine 212 and compiled by statistics engine 212 with other query information from other users for generating statistics. The generated statistics may be stored in a database 206. Registered commercial entities may obtain, for free or by purchase, the statistics stored in database 206.

Query response management module 214 may distribute user queries and query responses. User queries may be received from user 104 via a network, and query responses may be distributed to user 104 via the network. For example, the network may be the Internet or any suitable network capable of receiving and communicating messages. In addition, particular user queries and responses can be made available to users submitting similar queries.

Further, management module 214 can associate information or data provided by a commercial entity with queries and query responses sent to the network users. In this way, a commercial entity can provide advertising information to users viewing the queries and/or query responses. For example, commercial entities may each maintain a website describing services and/or products. Links to a commercial entity's website can be attached to queries and query responses associated with the commercial entity. In this way, for example, an interested user can visit the website of a commercial entity that provided a query response. A commercial entity may provide compensation each time a user clicks on the link for being directed to its website. Related information about presenting queries, responses, and clicks on the links can be sent to statistics engine 212 for generating statistics, which may be made available to commercial entities.

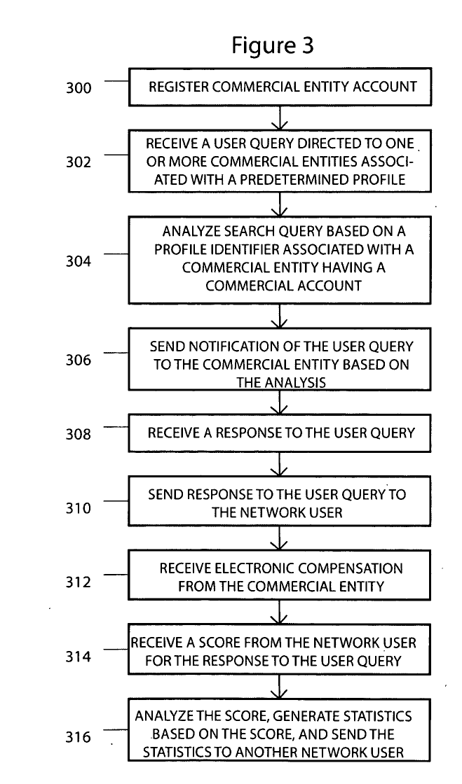

FIG. 3 is a flow diagram illustrating an exemplary process of associating a network user with a commercial entity according to an embodiment of the subject matter disclosed herein. In this example, reference is made to the system shown in FIG. 2 which is capable of implementing the process. Referring to FIGS. 2 and 3, a commercial account is registered with network server system 102 (block 300). Commercial entity 100 can use registration and management module 200 to register the commercial account. For example, module 200 can operate a registration webpage with which a representative of commercial entity 100 can register an account. The representative can enter the name of the commercial entity, compensation information, one or more profile identifiers, and contact information for the commercial entity (e.g., an email address of the representative, an office address, a facsimile number, and/or a phone number). Communication between system 102 and a client device of commercial entity 100 can be effected via the Internet by use of a suitable webpage interface.

The data entered by commercial entity 100 during the registration process can be stored in one or more of databases 206. For example, a database table stored in database 206 can include an entry containing an identifier for the commercial entity, profile identifiers, contact information for the commercial entity, and other suitable information. The database table can be in a format suitable for efficiently searching profile identifiers.

In block 302, system 102 receives a user query directed to one or more commercial entities associated with a predetermined profile. The user query can be any input received from a network user. For example, the user query can be a search query entered into a search engine webpage. In another example, the user query can be input into a merchandise webpage. In this example, the entry can be input into a webpage for selling products or services. Further, in this example, the input can be used for searching for products or services provided by the merchandiser operating the webpage.

A web server can receive the user query from a network component operated by user 104 by a web server, separate from system 102. The web server can send the user query to user interface 208. User interface 208 can acknowledge receipt of the query.

In block 304, the user query can be analyzed based on a profile identifier associated with a commercial entity having a commercial account. The user query or a portion of the user query can be forwarded to commercial entity selection module 220. In one example, the user query can include one or more words and/or phrases. Module 220 can compare the words and/or phrases to profile identifiers contained in the database table. If a word or a phrase contained in the user query matches a profile identifier in the database table, the user query or a portion of the user query can be tagged or otherwise associated with a commercial entity in the matching entry. Alternative to words and phrases contained in the user query, any other portion of the user query or data associated with the user query can be compared to profiler identifiers in the database table.

In block 306, notification of the user query is sent to the commercial entity based on the analysis. For example, commercial entity selection module 220 can determine commercial entities, if any, having a profile identifier matching words phrases, and/or other data contained in a search query, and send notification of the user query to the commercial entities with at least one matching profile identifier. In this example, commercial entity 100 can have an entry with a profile identifier matching data in the user query. If the profile identifier matches, notification of the user query can be sent to the commercial entity via a network connection, such as via the Internet.

Notification of a user query can be sent in any suitable manner. For example, the notification can be sent to a representative of the commercial entity via email. The email address can be contained in a database entry associated with the commercial entity. The email can include a link to a webpage managed by system 102 for presenting the user query or a portion of the user query to the representative.

In another example, notification of a user query can be sent via a webpage. A representative of the commercial entity can access a webpage managed by system 102. The webpage can provide notice of the user query. The representative can interact with the webpage to view all or a portion of the user query. The representative can select to receive all or a portion of the user query.

In block 308, a response to the user query is received from the commercial entity. The response can be sent to system 102 by email, by interface with a webpage, or any other suitable response over a network. The response can be sent by a representative of the commercial entity for presentation of the response to the network user associated with the user query.

In block 310, the response is sent to the network user. Query response management module 214 can receive the response and send the response to the network user. A database of contact information can be maintained for the network user, and the response sent to an address contained in the contact information.

The response can include contact information for the commercial entity providing the response. For example, the response can include a name, an office address, an email address, and/or a website address of the commercial entity. By providing the contact information to the network user, the network user can attempt to contact the commercial entity or find out other information about the commercial entity.

In block 312, billing module 202 can receive electronic compensation from the commercial entity for sending the response to the network user. The compensation can be provided in the form of a credit card payment, online payment, or any other suitable payment form.

In block 314, a score is received from the network user for the response to the user query. The score can be a number, letter, or the like grade rating for the response. The score can help to rate the response to others that may be interested in responses to the user query. This feature can be helpful if the response and user query are made available to other users. In addition, the score may be made available for helping others to evaluate the commercial entity. Statistics engine 212 can receive the score for statistic generation.

In block 316, the score can be analyzed, statistics can be generated based on the score, and the statistics can be sent to other network users. Statistics engine 212 can receive scores from network users and generate statistics based on the scores. The generated statistics can include average score for a commercial entity, number of scores for a commercial entity, and the like. The scores can be presented to network users via email, the Internet, or other suitable technique.

As stated herein, a query response can be presented to another network user. In one example, the query response can be presented to the network user along with a link to a website of the commercial entity that generated the response. Statistics engine 212 can generate statistics based on network users that clicked on the link to go to the commercial entity's website. Electronic compensation can be based on the number of network users that accessed the commercial entity's website by clicking on the link presented with the query response.

The executable instructions of a computer program for carrying out the method illustrated in FIG. 3 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

It will be understood that various details of the subject matter disclosed herein may be changed without departing from the scope of the disclosed subject matter. Furthermore, the foregoing description is for the purpose of illustration only, and not for the purpose of limitation, as the subject matter disclosed herein is defined by the claims as set forth hereinafter.

What is claimed is:

1. A method of associating a network user with a commercial entity associated with a predetermined profile, the method comprising:
receiving a user query directed to one or more commercial entities associated with a predetermined profile;
sending at least a portion of the user query to at least one commercial entity associated with the predetermined profile and having a commercial account; and
receiving a response to the user query from the at least one commercial entity for presentation of the response to a network user associated with the user query.

2. The method of claim 1 wherein receiving a user query comprises receiving the user query via the Internet, wherein sending the user query comprises sending the user query to the at least one commercial entity via the Internet, wherein receiving a response comprises receiving the response via the Internet, and
wherein the method comprises sending the response to the network user via the Internet.

3. The method of claim 1 wherein receiving a user query comprises receiving a user query directed to one or more commercial entities associated with one of a predetermined business-type category and geographic location information.

4. The method of claim 1 wherein sending at least a portion of the user query comprises sending at least a portion of the user query to an address associated with data contained in the user query.

5. The method of claim 1 comprising:
determining a profile identifier based on the user query; and
sending at least a portion of the user query to the at least one commercial entity having a profile identifier matching the determined profile identifier.

6. The method of claim 1 comprising:
sending the response to the network user; and
receiving electronic compensation from the at least one commercial entity for sending the response to the network user.

7. The method of claim 1 comprising receiving a score from the network user for the response to the user query.

8. The method of claim 7 comprising analyzing a plurality of scores from a plurality of network users for responses to user queries from the at least one commercial entity.

9. The method of claim 8 comprising:
generating a statistic based on the scores from the network users; and
sending the generated statistic to at least one network user.

10. A method of associating a network user with a commercial entity based on a search query, the method comprising:
analyzing a search query based on a profile identifier associated with a commercial entity having a commercial account;
sending notification of the search query to the commercial entity based on the analysis; and
receiving a response to the search query from the commercial entity for presentation of the response to a network user associated with the search query.

11. The method of claim 10 wherein analyzing a search query comprises comparing data contained in the search query with a profile identifier associated with the commercial entity.

12. The method of claim 11 wherein the data includes one or more search terms, and wherein analyzing the search query comprises comparing at least one of the search terms with the profile identifier, and wherein sending notification of the search query comprises sending notification of the search query to the commercial entity associated with the profile identifier matching the at least one of the search terms.

13. The method of claim 11 wherein the data includes one of business-type category and geographic location information, and wherein analyzing the search query comprises matching the one of the business-type category and geographic location information with the profile identifier, and wherein sending notification of the search query comprises sending notification of the search query to the commercial entity associated with the profile identifier matching the one of the business-type category and geographic location information.

14. The method of claim 10 wherein sending notification of the search query comprises sending notification of the search query via the Internet, and wherein receiving a response to the search query comprises receiving the response to the search query via the Internet; and
wherein the method comprises sending the response to the network user via the Internet.

15. The method of claim 10 wherein sending notification of the search query comprises sending notification of the search query to an address associated with data contained in the search query.

16. The method of claim 10 comprising receiving the search query based on a search performed by the network user using an Internet search engine.

17. The method of claim 16 comprising sending search engine results from the Internet search engine to the network user, and wherein the method comprises sending the response to the search query to the network user.

18. The method of claim 17 wherein sending search engine results comprises sending a first webpage containing the search engine results to the network user prior to receiving the response to the search query, and wherein sending the response comprises sending a second webpage containing the response to the network user in response to receiving the response from the commercial entity.

19. The method of claim 10 comprising:
receiving a score from the network user for the response to the search query;
generating a statistic based on the score; and
sending the generated statistic to a plurality of network users.

20. The method of claim 10 comprising sending the response to the search query to the network user.
